(19) United States
(12) Patent Application Publication
(10) Pub. No.: US 2003/0183698 A1
(43) Pub. Date: Oct. 2, 2003

(54) Module structure of portable memory unit

(75) Inventor: Kuei-Tung Wu, Taipei (TW)

Correspondence Address: BRUCE H. TROXELL, SUITE 1404, 5205 LEESBURG PIKE, FALLS CHURCH, VA, 22041, US

(73) Assignee: SPEED TECH CORP.

(21) Appl. No.: 10/106,243

(22) Filed: Mar. 27, 2002

(51) Int. Cl. G06K 19/06

(52) U.S. Cl. 235/492

(57) ABSTRACT

Module structure of portable memory unit including a control module in which a control circuit is disposed and a drawable module in which a memory is disposed. The drawable module is detachably electrically connected with the control module by a connector and a socket. The control module and the drawable module are formed with cooperative locating structures for associating the control module and drawable module with each other. A user is able to conveniently replace the drawable module with another having different specification and capacity as necessary for expanding the capacity and enlarging the application range of the memory unit.

### BACKGROUND OF THE INVENTION

The present invention is related to a module structure of portable memory unit, which enables a user to conveniently replace the memory with another having different specification and capacity as necessary.

A flash RAM module has greatly increased memory capacity with the volume maintained under a certain limitation. The flash RAM module has light weight and thin thickness and can be easily carried to satisfy various requirements of data register or low capacity data storage. Via a standardized universal serial bus (USB), the memory can be connected with a personal computer or notebook-type computer.

The above portable memory unit using USB as transmission interface generally simply includes an integral circuit module disposed in a housing. The circuit module includes a control unit and a memory unit. In production, different memory units are co-used with the same control unit to form different capacity and specification of products for different requirements. Such structure has shortcomings as follows:

In the case that the capacity of the memory unit is insufficient, a user must purchase another memory unit with greater capacity. In fact, only the memory unit with greater memory capacity is needed, while the control unit is repeatedly bought. Therefore, the cost for the control unit is wasted.

Moreover, in case one of the control unit and memory unit fails, the entire memory must be repaired or even discarded. This also leads to inconvenience and waste.

In addition, the control unit and memory unit are integrally connected so that the volume of the portable memory is larger and it is inconvenient to carry the portable memory.

### SUMMARY OF THE INVENTION

It is therefore a primary object of the present invention to provide an improved module structure of portable memory unit including a control module and a drawable module. A control circuit is disposed in the control module, while the memory is disposed in the drawable module. The drawable module is detachably electrically connected with the control module by a connector and a socket. In addition, the control module and the drawable module are formed with cooperative engaging structures for associating the control module and drawable module with each other. A user is able to conveniently replace the drawable module with another having different specification and capacity as necessary for expanding the capacity and enlarging the application range of the memory unit as well as avoiding waste.

It is a further object of the present invention to provide the above module structure of portable memory unit in which multiple different drawable modules can be replaceably used with one single control module so as to meet the requirements of different situations and store different kinds of data. Therefore, the cost for purchasing the control module is saved.

It is still a further object of the present invention to provide the above module structure of portable memory unit in which the control module and drawable module can be respectively inspected and repaired or replaced. This reduces inconvenience in use and lowers the reparation cost. Moreover, the drawable module has smaller volume so that it is easy to carry the portable memory unit.

The present invention can be best understood through the following description and accompanying drawings wherein:

### BRIEF DESCRIPTION OF THE DRAWINGS

FIG. 1 is a perspective exploded view of the present invention;

FIG. 2 is a sectional exploded view of the present invention;

FIG. 3 is a perspective assembled view of the present invent ion; and

FIG. 4 is a sectional assembled view of the present invention.

### DETAILED DESCRIPTION OF THE PREFERRED EMBODIMENT

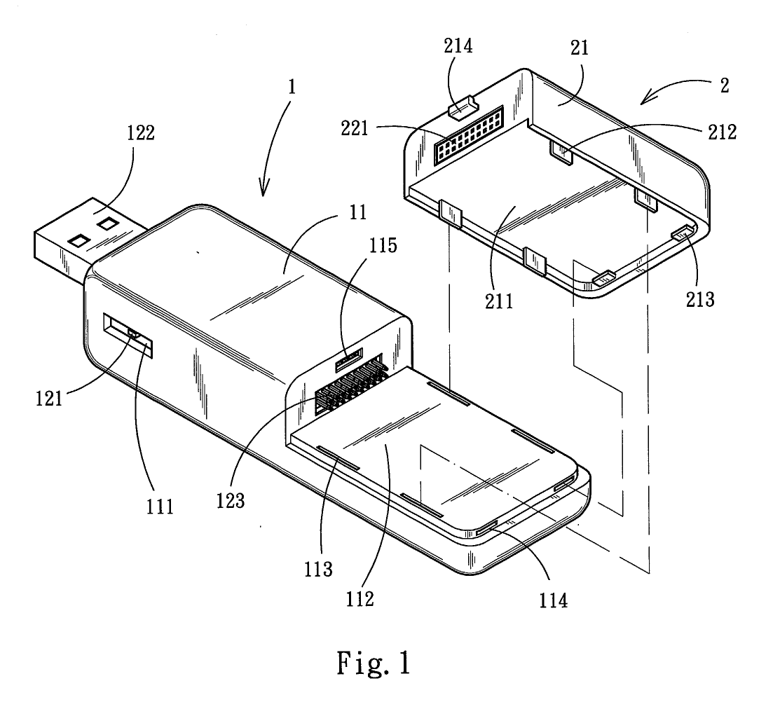

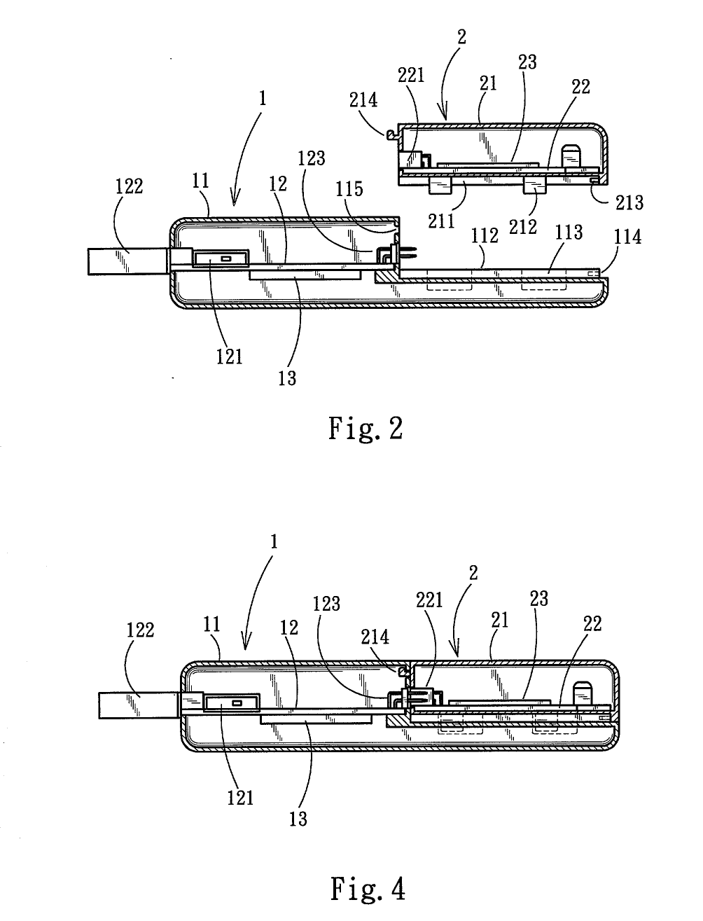

Please refer to FIGS. 1 and 2. The present invention includes a control module 1 and a drawable module 2. The control module 1 is composed of a main housing 11, a control circuit board 12 and a control chip 13. The main housing 11 is formed with a depression extending from the middle portion to one end of the main housing 11. The center of top face of the depression is formed with an upward projecting section 112. The top face of the periphery of the projecting section 112 is formed with multiple slide slits 113. The vertical face of the periphery of the projecting section 112 is formed with multiple insert ion dents 114. The control circuit board 12 is received in the main housing 11. The control chip 13 and a switch 121 are disposed on the control circuit board 12. The control chip 13 serves as a control interface between the memory and the relevant computer units. The shift bar of the switch 121 outward extends through a window 111 formed on a lateral side of the main housing 11 for a user to switch the writing function. One end of the control circuit board 12 is equipped with a connector 123 extending out from the main housing 11 to upper side of the projecting section 112. An insertion cavity 115 is formed on the main housing above the outward extending section of the connector 123. The other end of the control circuit board 12 is equipped with a plug 122 extending out from the other end of the main housing 11. The drawable module 2 is composed of a drawable housing 21, a memory circuit board 22 and a memory chip 23. The bottom side of the drawable housing 21 is formed with a recess 211 for fitting onto the projecting section 112 of the control module 1. The periphery of the top face of the recess 211 is formed with multiple downward extending vertical slats 212 corresponding to the slide slits 113. In addition, the periphery of the recess 211 is formed with multiple horizontal slats 213 corresponding to the insertion dents 114. The memory circuit board 22 is received in the drawable housing 21. The memory chip 23 is disposed on the memory circuit board 22. One end of the memory circuit board 22 is equipped with a socket 221 extending out from the drawable housing 21 for connecting with the connector 123. A hook board 214 outward projects from the drawable housing 21 above the outward extending section of the socket 221 corresponding to the insertion cavity 115 of the control module 1.

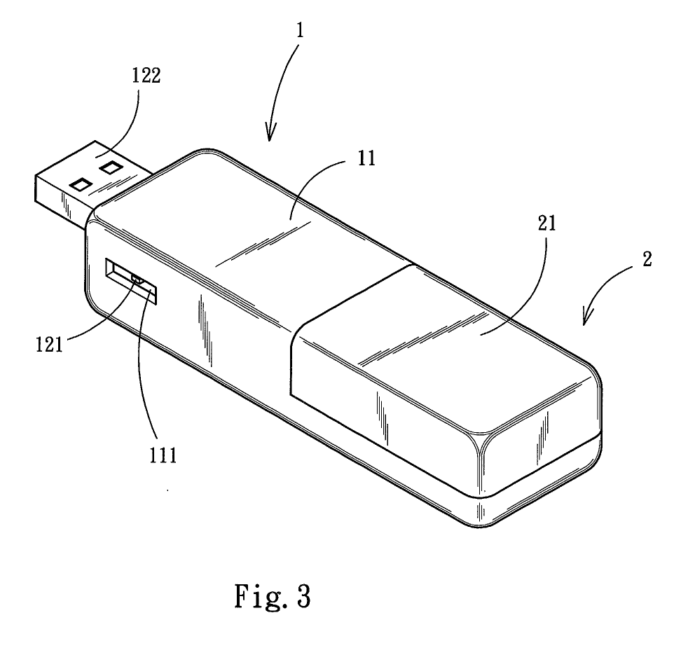

Referring to FIGS. 3 and 4, when assembled, the recess 211 of the drawable housing 21 is fitted onto the projecting section 112 of the main housing 11. The vertical slats 212 are inserted into the slide slits 113 and the horizontal slats 213 are aimed at the insertion dents 114. The drawable housing 21 is pushed to inlay and locate the hook board 214 in the insertion cavity 115 of the main housing 11. (At this time, the horizontal slats 213 are inserted into the insertion dents 114 to locate the other side of the drawable housing 21.) The connector 123 is plugged into the socket 221 to electrically connect the control circuit board 12 of the control module 1 with the memory circuit board 22 of the drawable module 2. The plug 122 of the control module 1 can be connected with a personal computer or notebook-type computer.

The hook board 214 is hooked and held in the insertion cavity 115 and the horizontal slats 213 are inserted in the insertion dents 114 to firmly associate the drawable housing 21 with the main housing 11. The connector 123 is plugged into the socket 221 to electrically connect the drawable module 2 with the control module 1. When the drawable module 21 is pulled rearward to extract the hook board 214 and horizontal slats 213 out of the insertion cavity 115 and insertion dents 114, the connector 123 is disconnected from the socket 221 and the drawable housing 21 and loosened from the main housing 11. Accordingly, the control module and drawable module can be easily assembled and disassembled. A user is able to conveniently replace the drawable module 2 with another having suitable memory capacity in accordance with actual requirement.

The above embodiment is only used to illustrate the present invention, not intended to limit the scope thereof. Many modifications of the above embodiment can be made without departing from the spirit of the present invention.

What is claimed is:

1. Module structure of portable memory unit comprising:
a drawable module including a drawable housing in which a memory circuit having a memory is disposed, the memory circuit having a connecting means outward projecting from the drawable housing; and
a control module including a main housing in which a control circuit having a control unit is disposed, one side of the control circuit being connected with a plug for connecting with a personal computer or notebook-type computer, the other side of the control circuit having a connecting means corresponding to the connecting means of the drawable module, whereby the connecting means of the control module is easily electrically connectable with the drawable module and the drawable module is freely replaceable with another having different specification for expansion and mobile application of the memory unit.

2. Module structure of portable memory unit as claimed in claim 1, wherein the main housing and the drawable housing are formed with corresponding engaging structures for firmly associating the main housing and drawable housing with each other.

3. Module structure of portable memory unit as claimed in claim 1, wherein the corresponding connecting means of the main housing and the drawable housing are a connector and a socket.

4. Module structure of portable memory unit as claimed in claim 1, wherein, the main housing is formed with at least one insertion cavity and insertion dent and the drawable housing is formed with at least one hook board and horizontal slats extending in a direction parallel to the insertion direction of the connecting means, whereby after the connecting means are inserted and connected with each other, the hook board and horizontal slats are respectively inserted into the insertion cavity and insertion dent to firmly engage the main housing with the drawable housing.

5. Module structure of portable memory unit as claimed in claim 2, wherein, the main housing is formed with at least one insertion cavity and insertion dent and the drawable housing is formed with at least one hook board and horizontal slats extending in a direction parallel to the insertion direction of the connecting means, whereby after the connecting means are inserted and connected with each other, the hook board and horizontal slats are respectively inserted into the insertion cavity and insertion dent to firmly engage the main housing with the drawable housing.

6. Module structure of portable memory unit as claimed in claim 3, wherein, the main housing is formed with at least one insertion cavity and insertion dent and the drawable housing is formed with at least one hook board and horizontal slats extending in a direction parallel to the insertion direction of the connecting means, whereby after the connecting means are inserted and connected with each other, the hook board and horizontal slats are respectively inserted into the insertion cavity and insertion dent to firmly engage the main housing with the drawable housing.

7. Module structure of portable memory unit as claimed in claim 4, wherein multiple vertical slats and slide slits are formed on the contact faces of the main housing and the drawable housing, the vertical slats and slide slits extending in a direction perpendicular to the insertion direction of the connecting means for guiding the drawable housing to slide on the main housing and associate therewith.

8. Module structure of portable memory unit as claimed in claim 5, wherein multiple vertical slats and slide slits are formed on the contact faces of the main housing and the drawable housing, the vertical slats and slide slits extending in a direction perpendicular to the insertion direction of the connecting means for guiding the drawable housing to slide on the main housing and associate therewith.

9. Module structure of portable memory unit as claimed in claim 6, wherein multiple vertical slats and slide slits are formed on the contact faces of the main housing and the drawable housing, the vertical slats and slide slits extending in a direction perpendicular to the insertion direction of the connecting means for guiding the drawable housing to slide on the main housing and associate therewith.

10. Module structure of portable memory unit as claimed in claim 1, wherein a switch is disposed on the control circuit board for operating the writing mode of the control module, the main housing being formed with a window corresponding to the switch, whereby the switch outward protrudes from the window for easy operation.
